(19) United States
(12) Patent Application Publication
(10) Pub. No.: US 2023/0038041 A1
(43) Pub. Date: Feb. 9, 2023

(54) ROMAN SHADE CURTAIN

(71) Applicant: HEE JIN PARK, Gwangju-si Gyeonggi-do (KR)

(72) Inventor: HEE JIN PARK, Gwangju-si Gyeonggi-do (KR)

(21) Appl. No.: 17/970,579

(22) Filed: Oct. 21, 2022

Related U.S. Application Data
(63) Continuation of application No. PCT/KR2021/004239, filed on Apr. 6, 2021.

(30) Foreign Application Priority Data
Apr. 21, 2020 (KR) 10-2020-0047842

(51) Int. Cl. E06B 9/262

(52) U.S. Cl. CPC E06B 9/262; E06B 2009/2622

(57) ABSTRACT

The present disclosure relates to a roman shade curtain which can improve a curtain atmosphere and the interior of a house by folding or unfolding the curtain in a stepwise manner like a lace. The roman shade curtain can be easily folded or unfolded in a stepwise manner by adopting a combination of rods and rings as a means for corrugating the middle of the curtain, so that the roman shade curtain may have a simple structure, be easily manufactured, and have excellent durability and improve the appearance of the curtain by arranging rods, rings, and the like on the rear surface of the curtain as well as wires for curtain operation.

### CROSS-REFERENCE TO RELATED APPLICATION

This application is a US Bypass Continuation Application of International Application No. PCT/KR2021/004239, filed on Apr. 6, 2021, and designating the United States, the International Application claiming a priority date of Apr. 21, 2020, based on prior Korean Application No. 10-2020-0047842, filed on Apr. 21, 2020, the disclosure of which is incorporated herein by reference in its entirety.

### BACKGROUND

### Technical Field

The present disclosure relates to a roman shade curtain which can improve a curtain atmosphere and the interior of a house by folding or unfolding the curtain in a stepwise manner like a lace.

### Background Art

In general, curtains are used to cover light or objects in everyday life, such as covering the sunlight or covering the stage.

Such curtains may be classified into various types according to their shapes, for example, a normal curtain which is unfolded and folded to the left and right sides, a vertical blind which is composed of a plurality of pieces for adjusting a tilt angle, a roll screen curtain which is wound and unwound on a roll which is rotated, and a roman shade curtain which is folded or unfolded in a stepwise manner by winding a length adjusting wire.

Recently, as not only the function of the curtain but also the aesthetic elements are considered important, the roman shade curtain, which has a beautiful folding shape, is gaining popularity.

The roman shade curtain has a beautiful appearance when the roman shade is completely lifted because a plurality of wrinkles is fundamentally formed as the curtain unit is folded and lifted. As an example, Korean Patent Registration Publication No. 10-1163864 discloses a roman shade type blind.

The roman shade type blind includes a fabric 3, a ring 4, and a cord wire 5.

The fabric 3 is woven by interweaving warp 1 and weft 2, and some of the weft 2 is not interwoven with the warp 1 to form a ring 4.

A ring 4 is formed by the interweave of a warp 1 passing between wefts 2 and some of the weft 2 is excluded from the interweave of the warp 1, so that the weft 2 on the unit which does not pass the warp 1 gathers together.

Therefore, the cord wire 5 passes through the ring 4 formed as described above, thereby completing the roman shade type blind.

However, in the roman shade type blind according to the related art, the ring 4 needs to be separately configured in order for the cord wire 5 to be connected to the fabric 3, and for this, some of the weft 2 should not be interwoven with the warp 1, which causes a problem that weaving process is complicated.

Further, to form the ring 4, some of the weft 2 is not interwoven with the warp 1, and thus, durability of a corresponding portion is weak.

### SUMMARY

### Technical Problem

Therefore, the present disclosure was devised considering these issues. An object of the present disclosure is to provide a new roman shade curtain which can be easily folded or unfolded in a stepwise manner by adopting a combination of rods and rings as a means for corrugating the middle of the curtain, so that the roman shade curtain may have a simple structure, be easily manufactured, and have excellent durability and improve the appearance of the curtain by arranging rods, rings, and the like on the rear surface of the curtain as well as wires for curtain operation.

### Technical Solution

To achieve the above object, the roman shade curtain provided in the present disclosure has the following characteristics.

As an exemplary embodiment of the present disclosure, the roman shade curtain includes a winding roll device, a driving wire, a driven wire, and a curtain, in which a plurality of tubular rod insertion units having at least one cut-out unit is formed on the rear surface of the curtain; a rod is inserted into the respective rod insertion unit in parallel to each other; a ring having an upper wire hanging unit and a lower rod hanging unit is disposed in the cut-out unit of the respective rod insertion unit; the driven wire is fixed to the wire hanging unit of the respective ring, and the rod is hung on the rod hanging unit; the driving wire extends from the winding roll device so as to be connected to the lowermost rod in the curtain; and the length of the driven wire between the driven wire knot units fixed to the wire hanging unit of the adjacent upper and lower rings is relatively shorter than the curtain length between the adjacent upper and lower rod insertion units on the curtain, so that the curtain is characterized to be folded or unfolded in a stepwise drooping form.

Here, the rod insertion unit of the curtain may be formed by bonding a two-layered folded band-shaped fabric with the rear surface portion of the curtain.

Further, it is preferable that a release paper is attached to an inner side of the two-layered rod insertion unit so that the two-layered fabric does not adhere to each other during thermal bonding.

According to a preferred embodiment, the rod insertion unit of the curtain may be integrally formed with the curtain through double weaving when the curtain is woven, and the rod insertion unit may be disposed at an interval relatively widened from an upper end portion of the curtain to a lower end portion of the curtain.

Meanwhile, as another example of a roman shade curtain provided by the present disclosure, the roman shade curtain includes a winding roll device, a driving wire, a driven wire, and a curtain, in which a plurality of unit rod insertion units is integrally woven by a double weaving method when the curtain is woven on the curtain; a plurality of rows of tubular rod insertion units shares the same axis line and is arranged in rows and a space part is formed therebetween; a rod is inserted and arranged inside the rod insertion unit of each row in parallel; a ring having an upper wire hanging unit and a lower rod hanging unit is disposed in the space part between the respective rod insertion unit; the driven wire is fixed to the wire hanging unit of the respective ring, and the rod is hung on the rod hanging unit; the driving wire extends from the winding roll device so as to be connected to the lowermost rod in the curtain; and the length of the driven wire between the driven wire knot units fixed to the wire hanging unit of the adjacent upper and lower rings is relatively shorter than the curtain length between the adjacent upper and lower rod insertion units on the curtain, thereby enabling the curtain to be folded or unfolded in a stepwise drooping form.

Here, the interval between the rod insertion units of the respective row forming the row on the curtain may be disposed at intervals that are relatively widened from the upper end portion of the curtain to the lower end portion of the curtain.

### BRIEF DESCRIPTION OF THE DRAWINGS

FIG. 1 is a perspective view illustrating a roman shade curtain according to an exemplary embodiment of the present disclosure.

FIG. 2 is a cross-sectional view illustrating a roman shade curtain according to an exemplary embodiment of the present disclosure.

FIG. 3 is an enlarged view illustrating a connection state of a rod, a ring, and a wire in the roman shade curtain according to the exemplary embodiment of the present disclosure.

FIG. 4 is an enlarged view illustrating a driving wire winding roll of the winding roll device in the roman shade curtain according to the exemplary embodiment of the present disclosure.

FIGS. 5A to 5D are perspective views illustrating a rod insertion unit in the roman shade curtain according to an exemplary embodiment of the present disclosure.

FIG. 6A and FIG. 6B are front views illustrating an example of a weaving method of a rod insertion unit formed in a curtain in a roman shade curtain according to an exemplary embodiment of the present disclosure.

FIG. 7A and FIG. 7B are front views illustrating another example of a weaving method of a rod insertion unit formed in a curtain in a roman shade curtain according to an exemplary embodiment of the present disclosure.

FIGS. 8 to 10 are perspective views illustrating a use state of a roman shade curtain according to an exemplary embodiment of the present disclosure.

### DETAILED DESCRIPTION

Hereinafter, the present disclosure will be described in detail with reference to the accompanying drawings.

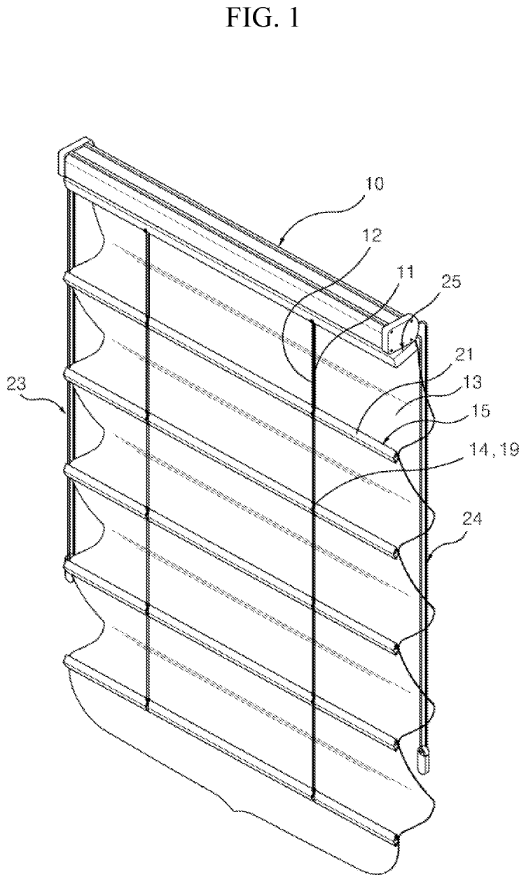

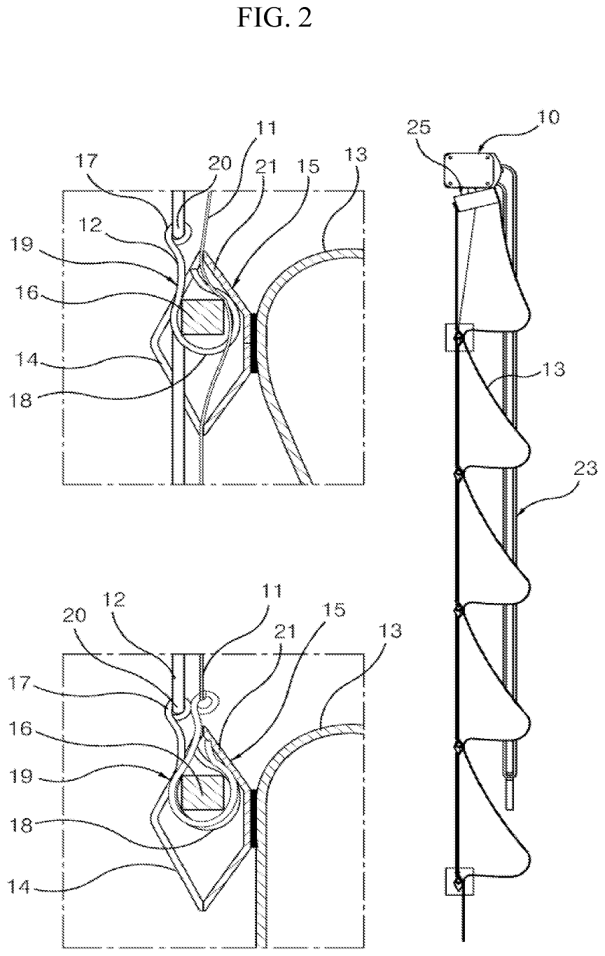

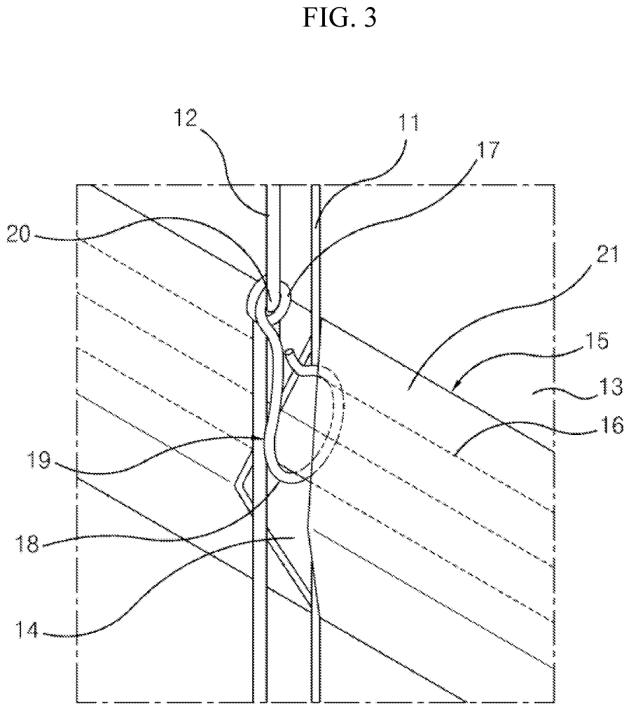

FIGS. 1 and 2 are a perspective view and a cross-sectional view illustrating a roman shade curtain according to an exemplary embodiment of the present disclosure, and FIG. 3 is an enlarged view illustrating a connection state of a rod, a ring, and a wire in the roman shade curtain according to an exemplary embodiment of the present disclosure.

As shown in FIGS. 1 to 3, the roman shade curtain includes a winding roll device as a means for providing power for folding and unfolding operations of a curtain 13.

The winding roll device 10 is a known winding roll device which winds or unwinds a driving wire 11 when a curtain 13 is folded or unfolded and may be installed in a transverse direction at an upper end portion of a window or the like for use.

At least one manipulation wire is applied to the winding roll device 10 as a means for a user to manipulate the curtain 13 when the user winds or unwinds the curtain, and in one exemplary embodiment of the present disclosure, an example is provided in which a first manipulation wire 23 for winding or unwinding the driving wire 11 when the curtain 13 is folded or unfolded is applied.

Here, the internal structure and the operation method of the winding roll device 10 may use a known winding roll device used for a general curtain or a blind, and a detailed description thereof will be omitted.

Accordingly, when one wire of the first manipulation wires 23 is pulled downward, the driving wire 11 is wound toward the winding roll device 10 to fold the curtain 13 upward, and when the other wire of the first manipulation wires 23 is pulled downward, the driving wire 11 is unwound from the winding roll device 10 to spread the curtain 10 downward.

As another example of the present disclosure, the winding roll device 10 may further include a second manipulation wire 24 and an auxiliary frame 25 to be used when the curtain 13 is completely folded and dropped down.

The second manipulation wire 24 is positioned at one side of the winding roll device 10, for example, at the opposite side of a side at which the first manipulation wire 23 is positioned and is connected to the winding roll device 10.

Further, the auxiliary frame 25 has a square bar shape, and the upper end portion of the curtain 13 is attached to the front surface of the auxiliary frame 25 by adhesion or the like, and the upper end portion of the driven wire 12 is fixed to the rear surface thereof.

The auxiliary frame 25 is arranged in parallel at the bottom of the winding roll device 10 and is installed in a structure supported by the winding roll device 10 using an auxiliary driving wire 32.

For example, two holes 26a and 26b are formed at each of both sides of the auxiliary frame 25, the auxiliary driving wire 32 is inserted upward from the bottom into one hole 26a of the two holes 26a and 26b formed as described above, one end portion of the auxiliary driving wire 32 is caught by the bottom surface of the auxiliary frame 25 through a knot or a hanging piece 27 so as not to fall upward, and the other end portion of the auxiliary driving wire 32 extends upward and is connected to the winding roll device 10.

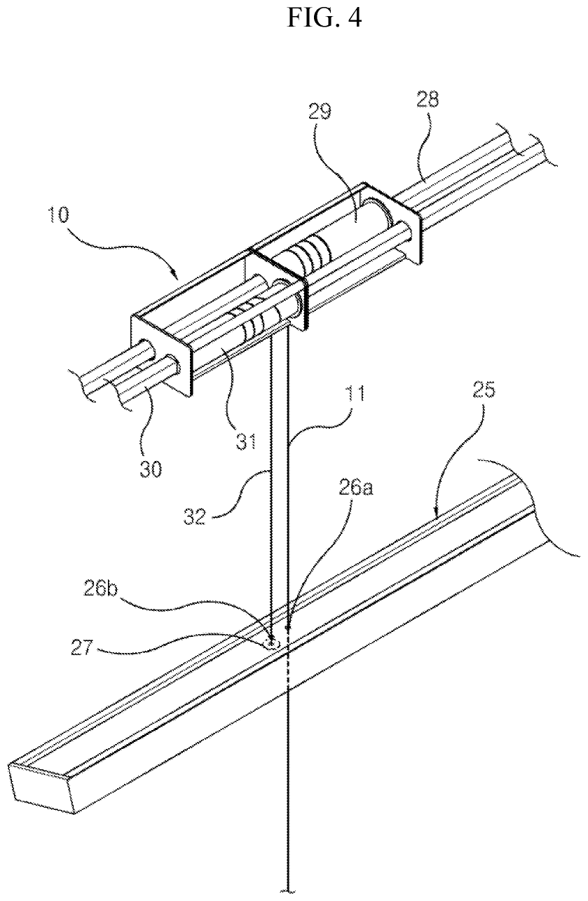

That is, as shown in FIG. 4, the winding roll device 10 is provided therein with a first driving shaft 28 which rotates according to the operation of the first manipulation wire 23, a first driving roll 29 which is coupled to the first driving shaft 28 and rotates together therewith, a second driving shaft 30 which rotates according to the operation of the second manipulation wire 24, and a second driving roll 31 which is coupled to the second driving shaft 20 and rotates together therewith.

Further, the driving wire 11 wound around the first driving roll 29 is connected to the lower end side of the curtain 13 after being extended downward, and the auxiliary driving wire 32 wound around the second driving roll 31 is connected to the auxiliary frame 25 after being extended downward.

In addition, one end portion of the driving wire 11 for folding and unfolding the curtain 13 is connected to the winding roll device 10 side and continuously escapes from the winding roll device 10 side to extend downward while passing through the remaining one hole 26b in the auxiliary frame 25, and then is connected to the rod 16 positioned at the lowermost end of the curtain 13, that is, the rod 16 inserted into the rod insertion unit 15 formed at the lowermost end of the curtain 13.

Accordingly, when the user operates the first manipulation wire 23, the winding roll device 10 is operated to unwind or wind the driving wire 11 connected to the curtain 13 side, such that the curtain 13 is unfolded or folded, and when the user operates the second manipulation driving wire 11, the winding roll device 10 is operated to unwind or wind the auxiliary driving wire 32 connected to the auxiliary frame 25, such that the auxiliary frame 25 is moved down or up.

In this case, when the auxiliary frame 25 is moved downward, the unfolded curtain 13 may also be folded downward.

Further, the roman shade curtain includes a curtain 13 made of a fabric material or a synthetic resin material, and an upper end portion of the curtain 13 may be supported in a structure attached to a front surface of the auxiliary frame 25, and a lower end portion of the curtain 13 may be maintained in a flat state without drooping by a weight of the rod 16.

A plurality of tubular rod insertion units 15 having at least one cut-out unit 14, for example, two cut-out units 14 disposed in the left-right width direction of the curtain is formed on the rear surface of the curtain 13, and each of the rod insertion units 15 formed in this way is disposed in parallel in the left-right width direction of the curtain and at the same time may be disposed at regular intervals in the up-down longitudinal direction of the curtain.

In particular, the rod insertion unit 15 may be formed by bonding the two-layered folded band-shaped fabric 21 with the rear surface portion of the curtain 13.

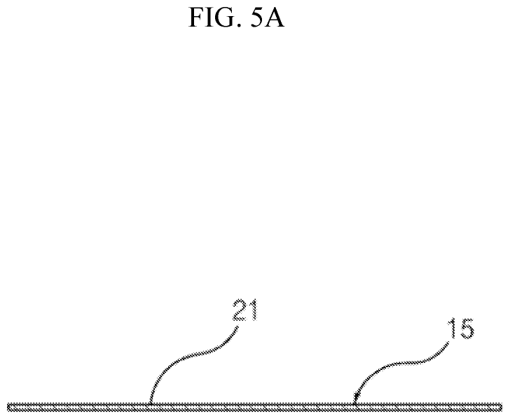

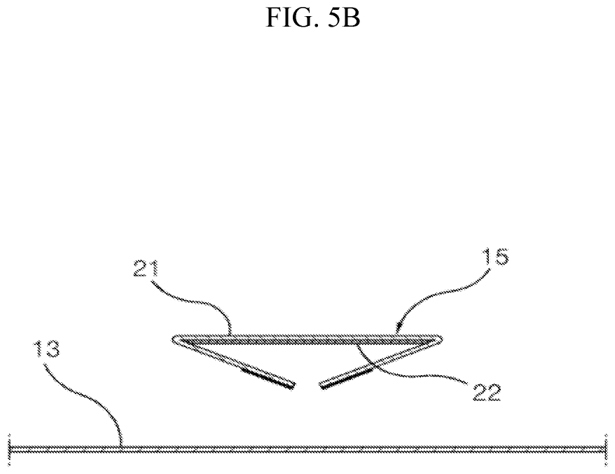

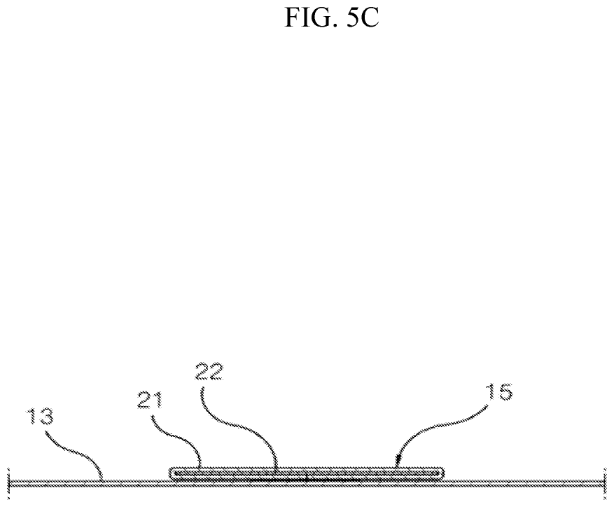

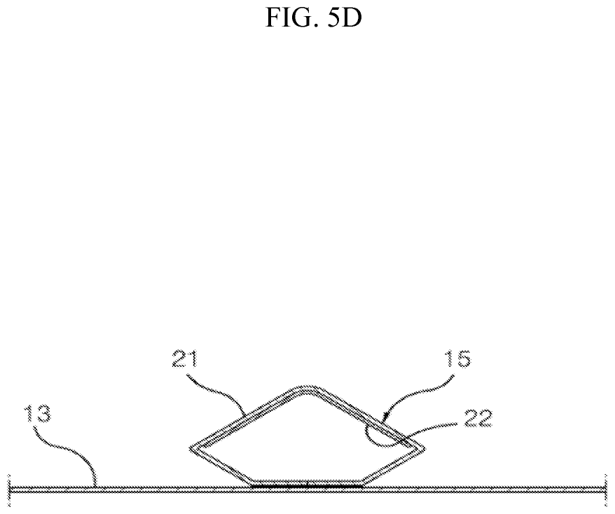

For example, as shown in FIGS. 5A to 5D, a long band-shaped fabric 21 made of the same material as the material of the curtain 13 is prepared, both ends of the fabric 21 in the width direction are folded inwardly in parallel to face each other in the middle of the width so as to be entirely double-layered, and then an adhesive such as hot melt is applied to the ends of the inwardly folded portions, that is, the ends that are in contact with each other.

Subsequently, when the inside of the fabric 21 coated with hot melt or the like closely adheres to the rear surface of the curtain 13 and is boned by applying heat, one layer of the inside of the rod insertion unit 15, that is, one layer made of the inwardly folded portion, is attached to the rear surface of the curtain 13, the one layer of the outside may form a space between the one layer of the inside and the one layer, and the rod 15 may be fitted into the space formed in this way.

Here, the cut-out unit 14 of the rod insertion unit 15 may be formed on one outer layer that is not attached to the rear surface of the curtain 13.

Further, in order to prevent the one outer layer from being attached to the one inner layer side at the time of the thermal bonding of the fabric 21, a release paper 22 such as a thin vinyl or film is attached to the inner side of the two-layered rod insertion unit 15, that is, the inner side of the one outer layer, such that the adhesive such as hot melt applied to the one inner layer and the one outer layer may be blocked by the release paper 22, and as a result, the two-layered fabric is not attached to each other due to the release paper 22 at the time of the thermal bonding.

In addition, the rod insertion units 15 may be formed at intervals that are relatively widened from the upper end portion of the curtain toward the lower end portion of the curtain.

As described above, by adopting the method of attaching and fixing the rod insertion unit 15 in the heat bonding method, the manufacturing may be easily performed as compared with the method of backstitching one by one using the sewing method, and as a result, mass production is possible, thereby improving productivity.

As another example, in the case of the rod insertion unit 15, in addition to a method of attaching and forming the separate fabric 21 in a heat bonding manner, the middle portion of the curtain 13 in the up-and-down longitudinal direction may be folded in a round manner to form a space sufficient for the rod 16 to be inserted, and then the overlapping portion may be stitched to form a space.

As another example, as a method of forming the rod insertion unit 15, the rod insertion unit 15 may be integrally formed through a double weaving method during curtain weaving.

For example, when the curtain 13 is woven, the following process is repeated: while the curtain body is woven in a single layer, the curtain body is woven in a double layer at a position where the rod insertion unit 15 is formed to form a space (rod insertion unit) into which the rod is fitted, and while the curtain body is woven in a single layer again, the curtain body is woven in a double layer again at a position where the rod insertion unit 15 is formed thereunder to form a space (rod insertion unit) into which the rod is fitted, and the like, thereby integrally forming the plurality of rod insertion units 15 through weaving on the curtain 13.

As described above, since the rod insertion unit 15 is integrally formed with the curtain through weaving, productivity related to the curtain manufacturing may be improved, and as a result, the curtain may be mass-produced.

Each rod 16 may be fitted into each rod insertion unit 15 formed on the rear surface of the curtain 13, and the rod 16 may be formed of a rectangular rod or a circular rod, such as a metal material or a plastic material, having a predetermined weight.

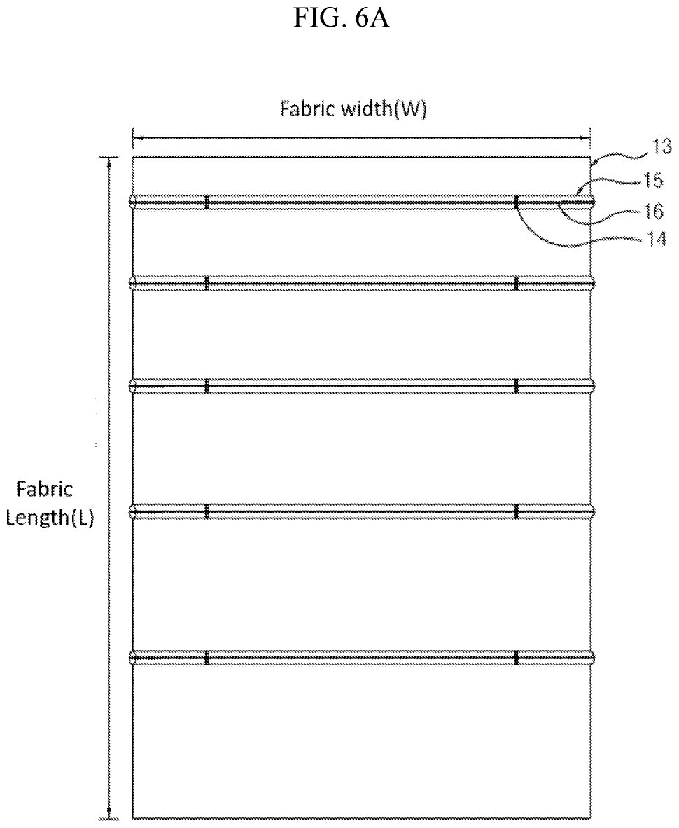

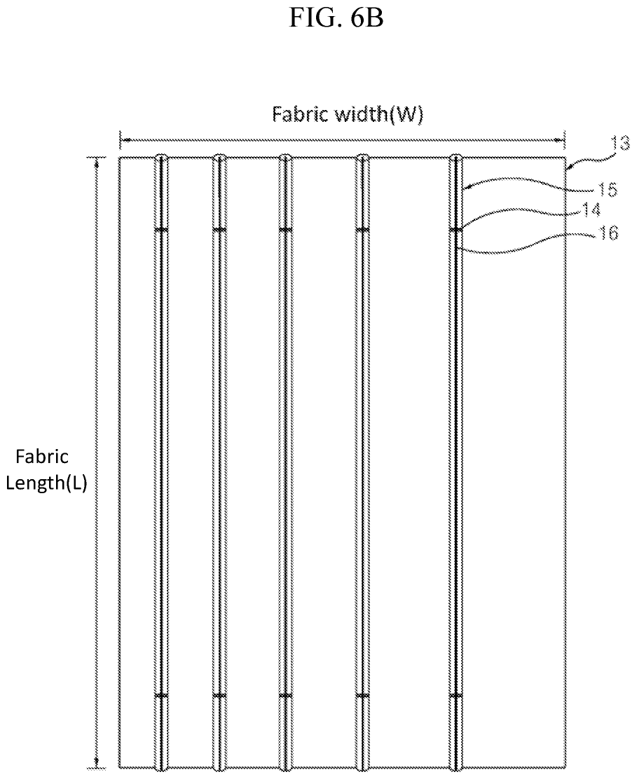

As shown in FIGS. 6A and 6B, the plurality of rod insertion units 15 woven on the curtain 13 may be disposed at intervals which are relatively increased from the upper end portion of the curtain to the lower end portion of the curtain.

For example, the interval between the rod insertion unit 15 disposed at the uppermost end of the curtain 13 and the rod insertion unit 15 disposed immediately below the rod insertion unit 15 is relatively smallest, and the interval between the rod insertion units 15 is gradually increased as it goes downward, and the interval between the rod insertion unit 15 disposed at the lowermost end of the curtain 13 and the rod insertion unit 15 disposed immediately above thereof is relatively largest.

As a result, the interval between the rod insertion units 15 is increased as it goes down the curtain 13.

Further, the rod insertion unit 15 formed on the curtain 13, that is, the rod insertion unit 15 woven together when the curtain 13 is woven, may be woven in parallel in the width direction of the fabric or in parallel in the length direction of the fabric.

As an example, when the curtain 13 is woven, the curtain 13 is formed by weaving the curtain fabric in the direction of the fabric width W (horizontal direction), the rod insertion unit 15 may be woven in parallel in the direction of the fabric width W.

As another example, when the curtain 13 is woven in the direction of the fabric length L (vertical direction) to manufacture the curtain 13, the rod insertion unit 15 may be woven in parallel in the direction of the fabric length L, and in this case, the curtain 13 may be laid on its side so that the rod insertion unit 15 may take a horizontal posture (the fabric length is laid left-and-right, and the fabric width is laid up-and-down).

When the curtain is woven in this manner, the rod insertion units (similarly, the rod insertion units attached to the curtain) integrally formed by being woven together are arranged at intervals that are relatively widened from the upper end portion of the curtain toward the lower end portion of the curtain so as to vary the intervals between the rod insertion units, thereby uniformly maintaining a folded shape as a whole when the curtain is folded and raised (when the roman shade is folded and raised) and thus further improving the aesthetic characteristics of the roman shade.

Further, the roman shade curtain includes a ring 19 as a means for shortening the vertical pitch (interval) between the rod insertion units 15 formed on the rear surface of the curtain 13 to be shorter than the normal state so that the curtain 13 has a stepped shape as if it were sagging downward like a lace shape.

The ring 19 is formed in the shape of a ring made by bending a wire or the like, and has a wire hanging unit 17 formed at the upper end portion thereof, and a rod hanging unit 18 formed at the lower end portion thereof, in which the driven wire 12 is tied to the wire hanging unit 17 so as to form a driven wire knot unit 20, and in which the rod 16 may be fitted into the rod hanging unit 18.

For example, the ring 19 is positioned at the cut-out unit 14 formed in the rod insertion unit 15 on the rear surface of the curtain 13, and the lower rod hanging unit 18 of the ring 19 positioned in this way hangs the rod 16 fitted in the rod insertion unit 15 while the driven line 12 is tied to the upper wire hanging unit 18 while forming the driven wire knot unit 20.

That is, a plurality of rings 19 is hung at regular up-down intervals in the middle of the length of the driven wire 12 by using the driven wire knot unit 20, and each rod 16 may be placed in a state of being hung on the rod insertion unit 15 of each ring 19 in this state.

In this case, the upper end portion of the driven wire 12 is fixed to the rear surface of the auxiliary frame 25, and in this state, the every middle portions of the driven wire 12 extending downward form the driven wire knot unit 20 while being tied to the wire hanging unit 18 of the ring 19, and thus, the length between the driven wire knot units 20 of the upper and lower rings 19 is maintained to be the maximum unfolded length when the curtain 13 is completely unfolded downward, and each of the upper and lower rods 16 hung on the rod hanging unit 18 of the upper and lower rings 19 may be held so as not to be further widened upward and downward.

In particular, the length of the driven wire between the driven wire knot units 20 of the driven wire 12 tied to the wire hanging units 17 of the upper and lower rings 19 adjacent to each other (the length of the driven wire between the driven wire knot units in the state in which the driven wire is maximally unfolded) is relatively shorter than the length of the curtain between the upper and lower rod insertion units 15 adjacent to each other on the curtain 13 (the length of the curtain between the rod insertion units in the state in which the curtain is not restricted by the ring, the driven wire, and the rod, and is freely unfolded).

Accordingly, when the curtain 13 fixed to the upper end of the auxiliary frame 25 is completely unfolded downward, the driven wire 12 fixed to the upper end of the auxiliary frame 25 is also completely straightened in a straight line and at the same time, the length between the driven wire knot units 20 is unfolded at maximum. And at this time, the length between the rod insertion units 15 of the curtain 13 is relatively longer than the length between the driven wire knot units 20, such that the curtain units between the rod insertion units 15, that is, parts of the curtain between the respective rods 16, may have a shape in which the lower part droops in a stepwise manner while the lower part thereof sags downward.

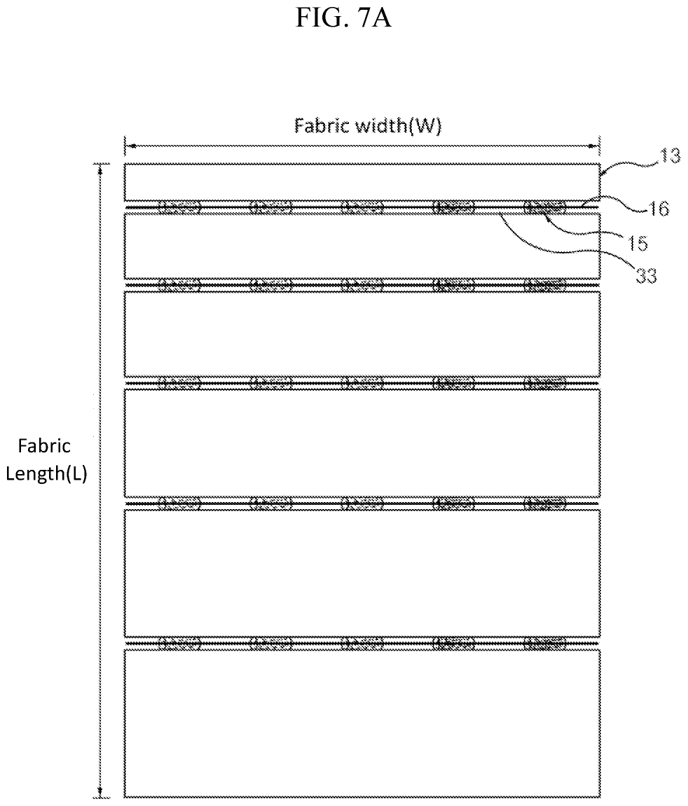

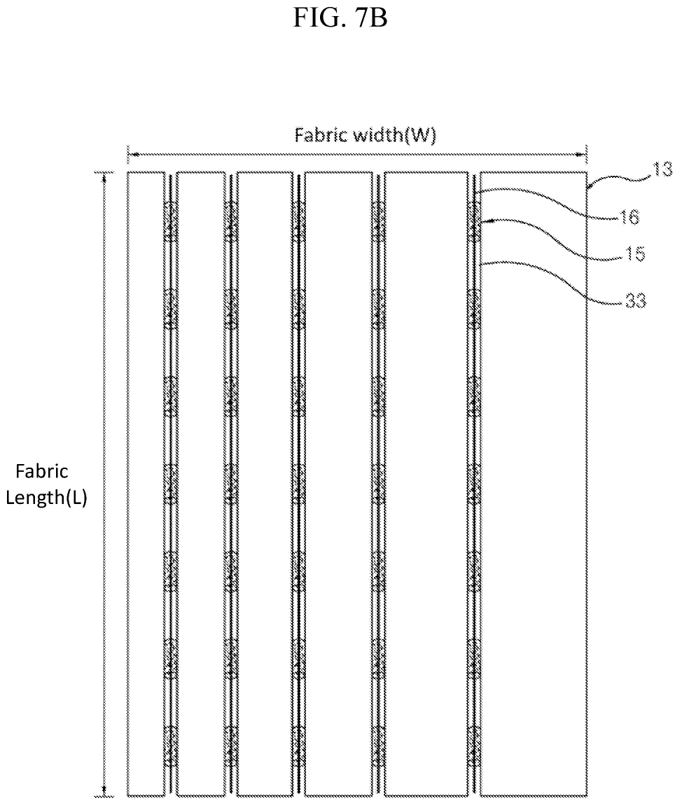

Meanwhile, as shown in FIGS. 7A and 7B, the plurality of tubular rod insertion units 15 woven on the curtain 13 may be disposed at intervals are relatively increased as it goes from the upper end portion to the lower end portion of the curtain.

For example, the interval between the rod insertion unit 15 disposed at the uppermost end of the curtain 13 and the rod insertion unit 15 disposed immediately below the rod insertion unit 15 is relatively smallest, and the interval between the rod insertion units 15 is gradually increased as it goes downward, and the interval between the rod insertion unit 15 disposed at the lowermost end of the curtain 13 and the rod insertion unit 15 disposed immediately above thereof is relatively largest.

As a result, the interval between the rod insertion units 15 is increased as it goes down the curtain 13.

Further, the rod insertion unit 15 formed on the curtain 13, that is, the rod insertion unit 15 woven together when the curtain 13 is woven, may be woven in parallel in the width direction of the fabric or in parallel in the length direction of the fabric.

As an example, when the curtain 13 is woven, the curtain 13 is formed by weaving the curtain fabric in the direction of the fabric width W (horizontal direction), the rod insertion unit 15 may be woven in parallel in the direction of the fabric width W.

As another example, when the curtain 13 is woven in the direction of the fabric length L (vertical direction) to manufacture the curtain 13, the rod insertion unit 15 may be woven in parallel in the direction of the fabric length L, and in this case, the curtain 13 may be laid on its side so that the rod insertion unit 15 may take a horizontal posture (the fabric length is laid left-right, and the fabric width is laid up-down).

When the curtain is woven in this manner, the rod insertion units (similarly, the rod insertion units attached to the curtain) integrally formed by being woven together are arranged at intervals that are relatively widened from the upper end portion of the curtain toward the lower end portion of the curtain so as to vary the intervals between the rod insertion units, thereby uniformly maintaining a folded shape as a whole when the curtain is folded and raised (when the roman shade is folded and raised) and thus further improving the aesthetic characteristics of the roman shade.

In particular, the rod insertion unit 15 may be integrally formed by a double weaving method when weaving a curtain. When the curtain 13 is woven, the following process is repeated: while the curtain body is in a single layer, the curtain body is woven in a double layer at a position where the rod insertion unit 15 is formed to form a space (rod insertion unit) into which the rod is fitted, and while the curtain body is woven in a single layer again, the curtain body is woven in a double layer again at a position where the rod insertion unit 15 is formed thereunder to form a space (rod insertion unit) into with the rod is fitted, and the like, thereby integrally forming the plurality of rod insertion units 15, for example, the plurality of rows of rod insertion units 15, through weaving on the curtain 13.

In this case, the rod insertion unit 15 of each row may be formed in a shape grouped in several units, rather than having a length corresponding to the entire width or the entire length of the curtain 13.

For example, a plurality of tubular unit rod insertion units forming the rod insertion unit 15 of each row may be arranged at regular intervals along the width direction of the curtain 13 (when woven in the horizontal direction) or along the length direction of the curtain 13 (when woven in the vertical direction), and each of the unit rod insertion units formed as described above, that is, each of the individual unit rod insertion units shares the same axis, such that one rod 16 is simultaneously inserted into each of the unit rod insertion units forming one row, and a space part 33 is formed between each of the unit rod insertion units to form an empty space in which the curtain fabric at the top and bottom is disconnected.

Further, the space part 33 formed between the unit rod insertion units serves to provide a connection space when connecting the ring 19 and the rod 16.

For example, the ring 19 is positioned in the space part 33 formed between each of the unit rod insertion units forming the rod insertion units 15 of each row of the curtain 13, and the lower rod hanging unit 18 of the ring 19 positioned in this way hangs the rod 16 inserted into the rod insertion unit 15, and at the same time, the driven wire 12 is tied in the upper wire hanging unit 18 while forming the driven wire knot portion 20.

In addition, the roman shade curtain includes a ring 19 as a means for shortening the vertical pitch (interval) between the rod insertion units 15 of each row formed on the curtain 13 to be shorter than the normal state so that the curtain 13 has a stepped shape as if it were sagging downward like a lace shape.

The ring 19 is formed in the shape of a ring made by bending a wire or the like, and has a wire hanging unit 17 formed at the upper end portion thereof, and a rod hanging unit 18 formed at the lower end portion thereof, in which the driven wire 12 is tied to the wire hanging unit 17 so as to form a driven wire knot unit 20, and in which the rod 16 may be fitted into the rod hanging unit 18.

For example, the ring 19 is positioned in the space part 33 formed between the left and right rod insertion units 15 of the curtain 13, and the lower rod hanging unit 18 of the ring 19, which is positioned in this way, hangs the rod 16 inserted into the rod insertion unit 15, and at the same time, the driven wire 12 is tied to the upper wire hanging unit 18 while forming the driven wire knot unit 20.

That is, a plurality of rings 19 is hung at regular up-and-down intervals in every middle portion of the length of the driven wire 12 by using the driven wire knot unit 20, and each rod 16 may be placed in a state of being hung on the rod insertion unit 15 of each ring 19 in this state.

In this case, the upper end portion of the driven wire 12 is fixed to the rear surface of the auxiliary frame 25, and in this state, the middle portion of the driven wire 12 extending downward forms the driven wire knot unit 20 while being tied to the wire hanging unit 18 of the ring 19, and thus, the length between the driven wire knot units 20 of the upper and lower rings 19 is maintained to be the maximum unfolded length when the curtain 13 is completely unfolded downward, and the upper and lower rods 16 hung on the rod hanging unit 18 of the upper and lower rings 19 may be held so as not to be further widened upward and downward.

In particular, the length of the driven wire between the driven wire knot units 20 of the driven wire 12 tied to the wire hanging unit 17 of the upper and lower rings 19 adjacent to each other (the length of the driven wire between the driven wire knot units in the state in which the driven wire is maximally unfolded) is relatively shorter than the length of the curtain between the upper and lower rod insertion units 15 adjacent to each other on the curtain 13 (the length of the curtain between the rod insertion units in the state in which the curtain is not restricted by the rings, the driven wire, and the rod and is freely unfolded).

Accordingly, when the curtain 13 fixed to the upper end of the auxiliary frame 25 is completely unfolded downward, the driven wire 12 fixed to the upper end of the auxiliary frame 25 is also completely straightened in a straight line and at the same time, the length between the driven wire knot units 20 is unfolded at maximum. And at this time, the length between the rod insertion units 15 of the curtain 13 is relatively longer than the length between the driven wire knot units 20, such that a part of the curtain between the rod insertion units 15, that is, the part of the curtain between the respective rods 16, may have a shape in which the lower part droops in a stepwise manner while the lower part thereof sags downward.

Therefore, the use state of the roman shade curtain configured as described above will be described below.

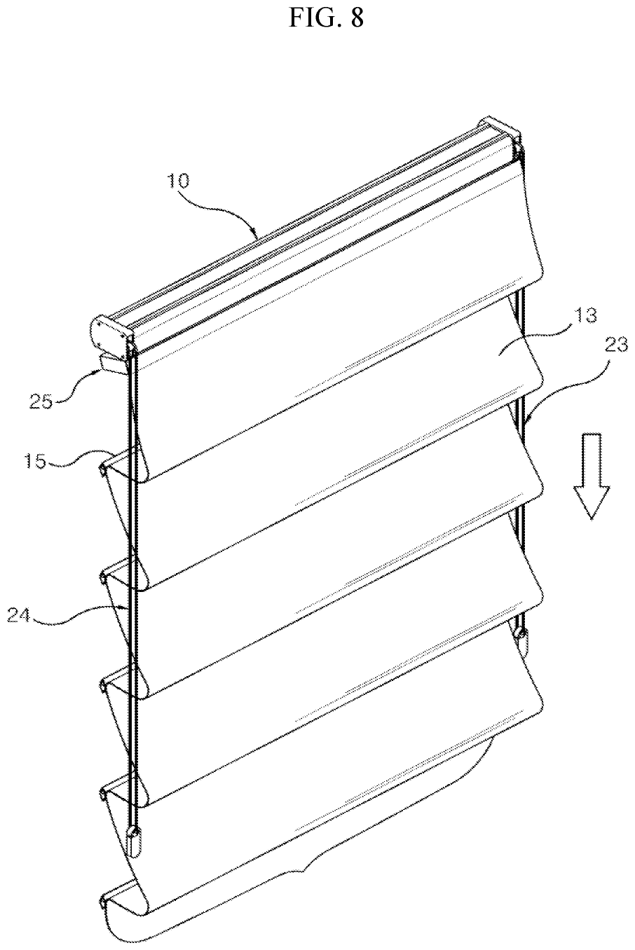

FIGS. 8 to 10 are perspective views illustrating a use state of a roman shade curtain according to an exemplary embodiment of the present disclosure.

As shown in FIG. 8, a state in which the curtain is completely unfolded is shown here.

To this end, when the user pulls one side of any of the first manipulation wire 23 downward, the driving wire 11 wound around the winding roll device 10 is unwound, that is, the driving wire 11 wound around the first driving roll 29 of the winding roll device 10 is unwound, and at the same time, the curtain 13 may be unfolded downward by its own weight.

In this case, the driven wire 12 is not unfolded any more in a state where the interval between the driven wire knot units 20 is unfolded in a tight manner, and as a result, the curtain 13 is not completely unfolded and is unfolded in a stepwise manner, like a lace, by the regulation action of the driven wire 12, thereby making it possible to boost the curtain atmosphere and the interior of the house.

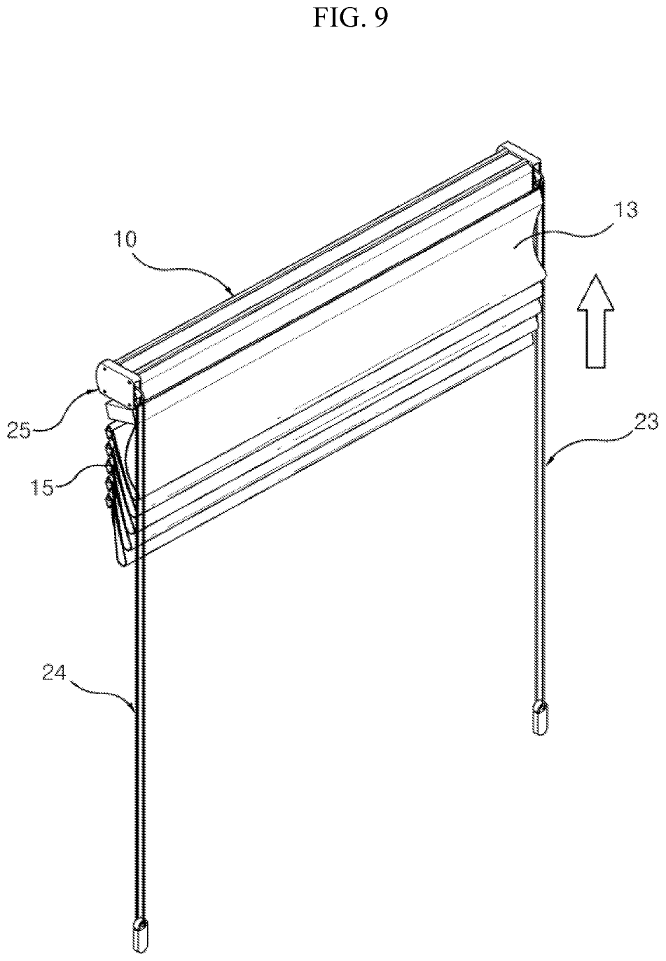

As shown in FIG. 9, a state in which the curtain is completely folded is shown here. To this end, when the user pulls the other side of the first manipulation wire 23 downward, the driving wire 11 is wound around the winding roll device 10, that is, the driving wire is wound around the first driving roll 29 of the winding roll device 10, and at the same time, the driving wire 11 fixed to the lower end portion of the curtain 13, that is, the driving wire 11 fixed to the rod 16 of the lowermost rod insertion unit 15 of the curtain 13 is pulled upward to pull the curtain 13 up, and as a result, the curtain 13 may be folded.

Even in this case, the curtain 13 is not completely unfolded, but is folded in a stepwise manner like a lace.

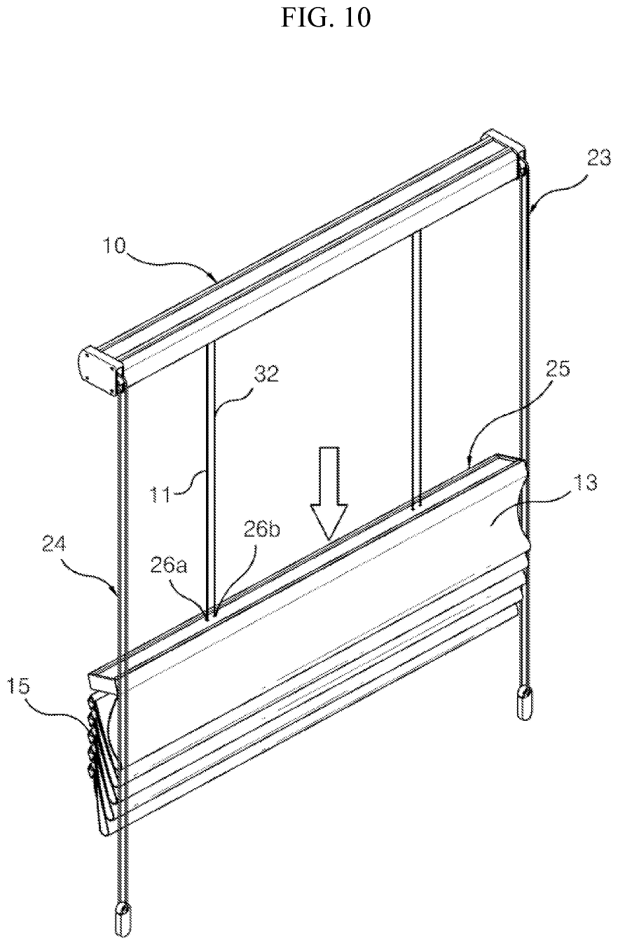

As shown in FIG. 10, a state in which the curtain 13 in the folded state is completely lowered down for shielding the light is shown here.

To this end, when the user pulls one side of the second manipulation wire 24 downward, the auxiliary driving wire 32 wound around the winding roll device 10 is unwound, that is, the auxiliary driving wire 32 wound around the second driving roll 31 of the winding roll device 10 is unwound, and at the same time, the auxiliary frame 25 is lowered downward by its own weight, and at the same time, the curtain 13 which has been unfolded may be naturally folded downward.

The roman shade curtain of the present disclosure, which is configured to have a rod and a rod insertion unit on a rear surface portion of the curtain fabric and a ring for connecting a driven wire and a rod, has the following effects.

First, the entire structure of the curtain can be simply and easily manufactured, and manufacturing costs can be reduced.

Second, the curtain of the present disclosure has a structure which supports the unfolding and folding operations of the curtain fabric by using a driven wire, a ring, and a rod, thereby obtaining excellent durability even when repeatedly unfolded and folded.

Third, rods and rings, as well as the driving wire and the driven wire for the operation of the curtain, are disposed behind the curtain so as not to be exposed to the front surface of the curtain at all, thereby improving the appearance of the curtain.

Fourth, when a rod insertion unit for inserting a rod into a curtain fabric is formed, the rod insertion unit is formed by thermally bonding and adhering a sheet fabric having a two-layered band shape to the rear surface of the curtain fabric, thereby improving the productivity of a curtain including the rod insertion unit and also securing the quality of a product so as not to show a sense of difference such as backstitching, on the front surface of the curtain.

As described above, the present disclosure applies a new roman shade curtain which is capable of easily folding or unfolding by forming the middle of the curtain in a corrugated stepped shape using a combination of rings, which regulate the intervals between the rods, and the like, in addition to rods inserted into the curtain side, thereby simplifying the structure of the curtain, easily manufacturing the curtain at a low cost, obtaining excellent durability, and improving the appearance and quality of the curtain by hiding the rod, the ring, and the like on the rear surface of the curtain as well as the wire for operating the curtain.

### EXPLANATION OF REFERENCE NUMERALS AND SYMBOLS

10: Winding roll device
11: Driving wire
12: Driven wire
13: Curtain
14: Cut-out unit
15: Rod insertion unit
16: Rod
17: Wire hanging unit
18: Rod hanging unit
19: Ring
20: Driven wire knot unit
21: Fabric
22: Release paper
23: First manipulation wire
24: Second manipulation wire
25: Auxiliary frame
26a, 26b: Holes
27: Hanging piece
28: First driving shaft
29: First driving roll
30: Second driving shaft
31: Second driving roll
32: Auxiliary driving wire
33: Space part

What is claimed is:

1. A roman shade curtain, comprising:
a winding roll device (10),
a driving wire (11),
a driven wire (12), and
a curtain (13), in which a plurality of tubular rod insertion units (15) having at least one cut-out unit (14) is formed on the rear surface of the curtain (13),
a rod (16) is inserted into the respective rod insertion unit (15) in parallel to each other;
a ring (19) having an upper wire hanging unit (17) and a lower rod hanging unit (18) is disposed in the cut-out unit (14) of the respective rod insertion unit (15),
the driven wire (12) is fixed to the wire hanging unit (17) of the respective ring (19), and the rod (16) is hung on the rod hanging unit (18),
the driving wire (11) extends from the winding roll device (10) to be connected to the lowermost rod (16) in the curtain (13), and
the length of the driven wire between the driven wire knot units (20) fixed to the wire hanging unit (17) of the adjacent upper and lower rings (19) is relatively shorter than the curtain length between the adjacent upper and lower rod insertion units (15) on the curtain (13), so that the curtain (13) is characterized to be folded or unfolded in a stepwise drooping form.

2. The roman shade curtain of claim 1, wherein
the rod insertion unit (15) of the curtain (13) may be formed by bonding a two-layered folded band-shaped fabric (21) with the rear surface portion of the curtain (13).

3. The roman shade curtain of claim 2, wherein
a release paper (22) is attached to an inner side of the two-layered rod insertion unit (15) so that the two-layered fabric does not adhere to each other during thermal bonding.

4. The roman shade curtain of claim 1, wherein
the rod insertion unit (15) of the curtain (13) may be integrally formed with the curtain through double weaving when the curtain is woven.

5. The roman shade curtain of claim 4, wherein
the rod insertion unit (15) may be disposed at an interval relatively widened from an upper end portion of the curtain to a lower end portion of the curtain (13).

6. A roman shade curtain, comprising:
a winding roll device (10),
a driving wire (11),
a driven wire (12), and
a curtain (13), in which a plurality of unit rod insertion units (15) is integrally woven by a double weaving method when the curtain is woven on the curtain (13),
a plurality of rows of tubular rod insertion units (15) shares the same axis line and is arranged in rows and a space part (13) is formed therebetween,
a rod (16) is inserted and arranged inside the rod insertion unit (15) of each row in parallel,
a ring (19) having an upper wire hanging unit (17) and a lower rod hanging unit (18) is disposed in the space part (33) between the respective rod insertion unit (15),
the driven wire (12) is fixed to the wire hanging unit (17) of the respective ring (19), and
the rod (16) is hung on the rod hanging unit (18);
the driving wire (11) extends from the winding roll device (10) to be connected to the lowermost rod (16) in the curtain (13); and
the length of the driven wire between the driven wire knot units (20) fixed to the wire hanging unit (17) of the adjacent upper and lower rings (19) is relatively shorter than the curtain length between the adjacent upper and lower rod insertion units (15) on the curtain (13), thereby enabling the curtain (13) to be folded or unfolded in a stepwise drooping form.

7. The roman shade curtain of claim 6, wherein
the interval between the rod insertion units (15) of the respective row forming the row on the curtain (13) may be disposed at intervals that are relatively widened from the upper end portion of the curtain to the lower end portion of the curtain.
